(19) United States
(12) Patent Application Publication
(10) Pub. No.: US 2009/0219524 A1
(43) Pub. Date: Sep. 3, 2009

(54) METHOD AND APPARATUS FOR CONTROLLED RAMAN SPECTROMETER

(75) Inventors: Tzu-Yu Wang, Maple Grove, MN (US); Paul E. Bauhahn, Fridley, MN (US); Jerome P. Drexler, Wyoming, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/040,838

(22) Filed: Feb. 29, 2008

(51) Int. Cl. G01J 3/44

(52) U.S. Cl. 356/301

(57) ABSTRACT

One embodiments includes a method that includes enabling an excitation laser during an excitation period, after a timed delay following the first excitation period, monitoring a photon scattering caused by the excitation laser, analyzing the photon scattering, automatically adjusting the timed delay to a modified timed delay based on the analyzed photon scattering and following the modified timed delay, enabling a Raman spectrometer to monitor Raman scattering caused by the excitation laser during a Raman monitoring period.

### BACKGROUND

Detection of Raman scattering can reveal the composition of a specimen. It is desirable to detect Raman scattering in various environments, including those in which noise interferes with the detection of Raman scattering.

### BRIEF DESCRIPTION OF THE DRAWINGS

FIG. 1 is a diagram of a Raman detector, according to some embodiments.

FIG. 2 is a flow chart of a method of adjusting a Raman spectrometer, according to some embodiments.

FIG. 3 is a flow chart of a method of adjusting transmission intensity, according to some embodiments.

FIG. 4 is a flow chart of a method of adjusting gate timing, according to some embodiments.

FIG. 5 is a diagram showing timing related to pulsed Raman spectroscopy, according to some embodiments.

FIG. 6 is a flow chart of a method of automatically adjusting a Raman spectrometer, according to some embodiments.

FIG. 7 is a flow chart of a method of automatically adjusting pulses of a controlled pulsed Raman spectrometer, according to some embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

It is desired to remotely detect the chemical composition of solids, liquids, and gasses. Specific applications that benefit from remote chemical detection include, but are not limited to, tailpipe and smoke-stack emission analysis, petrochemical gas leaks, liquid chemical spills, drug detection, puddles and hazardous material detection, CO₂ detection in vehicles crossing international borders, airport scanning such as automatic airport scanning, etc. The present subject matter is suited for use by various entities such as the Department of Defense of the United States and the Department of Homeland Security of the United States.

In various embodiments, the present subject matter uses an optical method to detect the molecular composition of remote specimens. Examples of specimens include, but are not limited to, a solid object, a gas cloud and a liquid puddle. Various embodiments report a molecular composition via a spectrometer that is part of a detector. Additional embodiments report a higher-level composition (e.g., petroleum, plant matter, narcotics, etc.) via determining constituents to the higher-level composition. Optical methods for detecting molecular compositions include, but are not limited to, methods that detect laser induced fluorescence (“LIF”) and Raman scattering.

In various embodiments, LIF provides a means for remotely detecting the chemical composition of objects. However, the selectivity of LIF is limited because the limited variety of spectra emitted from chemical(s) of interest. The limited range of such spectra makes it difficult to identify specific materials. In contrast, embodiments of the present subject matter rely on Raman spectroscopy to monitor scattered light comprised of several wavelengths. The present subject matter includes methods, systems and apparatus for a controlled spectrometer. Specifically, in various embodiments, method, system and apparatus of the present subject matter reduce the influence of background noise such as solar, lunar or artificial lighting energy on the fidelity of collected Raman spectra.

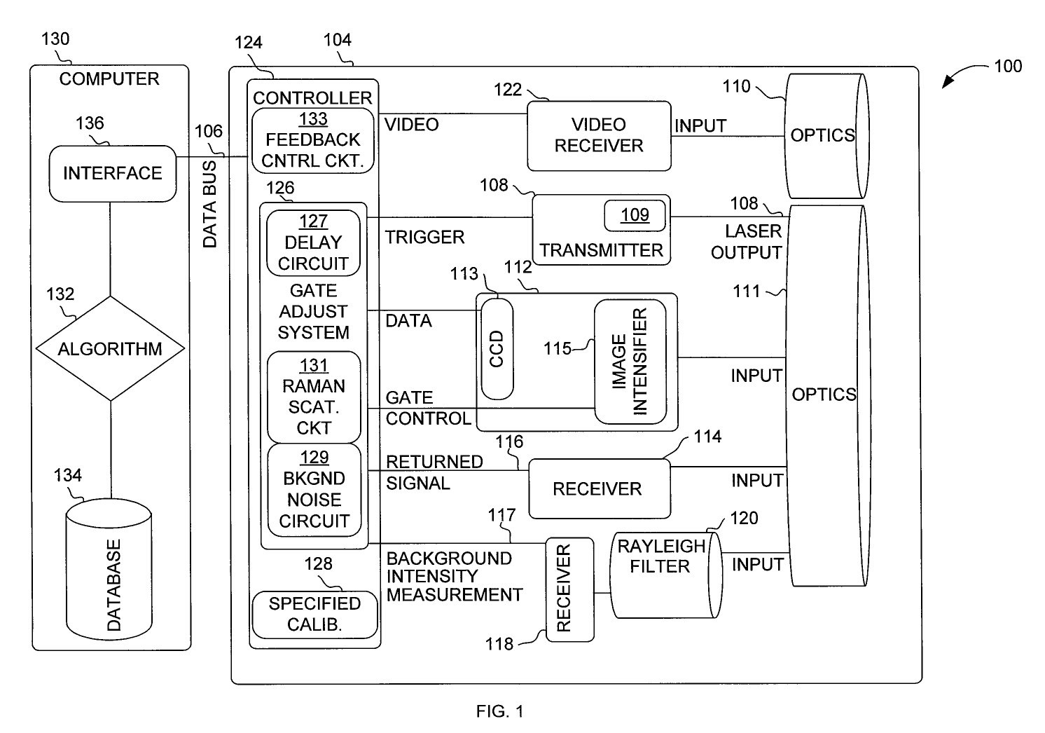

FIG. 1 is a diagram of a Raman detector system 100, according to some embodiments. According to various embodiments, a computer 130 is coupled to a Raman module 104. The data bus 106 is coupled to the Raman module 104, such as via a circuit board, in some embodiments. In some embodiments, a network is used for communications over data bus 106. In some examples, a network includes wireless communications. In additional examples, at least some of the communications are wired. Analog and digital signals can be transmitted through data bus 106.

Various embodiments include a transmitter or laser light source 108. In some examples, the laser light source 108 is controlled by an excitation circuit 109. The laser light source 108, in various embodiments, provides an excitation laser to cause Raman scattering. Examples of laser light sources include, but are not limited to, infrared, visible, ultraviolet and other lasers. In some examples, the laser light source 108 provides a laser for measuring distance, time of flight, multiple frequency phase-shifts and/or interferometry. In various embodiments, the laser light source 108 functions as a range finding laser to measure distance useful for adjusting any filters or optics in the path of the laser light, such as focusing the input optics. Visible lasers are used in some embodiments for accurate aiming as well as eye safety. Visible lasers are useful to encourage aiming and eye safety in some embodiments in which the laser used to evoke Raman scatter is not visible.

Laser optics 111 are used to process light leaving the Raman module 104 in various embodiments. In additional embodiments, laser optics 111 are used to process light received by the Raman module 104. Optics add functionality including, but not limited to, focusing laser light and collecting laser light such as Raman scattered light. Various embodiments of laser optics 111 include a collimating lens. The Raman detector system 100 also includes a dispersive optical element in various embodiments.

In some examples, the laser light source 108 provides an excitation laser to cause a reflective reaction so reaction background noise can be measured. Background noise is includes spectra that interfere with the collection of desired spectra. Desired spectra include Raman scattering, according to some embodiments. Background noise can include solar and lunar light, incandescent lamp light, and other light, in various examples. Noise information can include noise information from any spectra. Noise includes fluorescence in various embodiments. For example, short wavelength lasers can excite fluorescent materials such as from materials that are naturally fluorescent or other materials, such as fluorescent light bulbs. Fluorescence can be caused by a laser intended to excite Raman scattering. In some embodiments, the present subject matter automatically adjusts the laser, such as by adjusting pulse frequency, laser pulse width, laser pulse intensity or laser optics 111, to reduce the influence of fluorescence caused by the laser.

Various embodiments of the Raman module 104 include a photo-detector array 112. In various embodiments, the photo-detector array 112 is to detect Raman scattering, but the present subject matter is not so limited. Examples of photo-detector arrays to detect Raman scattering include, but are not limited to, charge-coupled devices (“CCD”) 113. Photomultiplier tubes (“PMT”) are additionally possible. Some examples include an image intensifier 115. In various embodiments, the image intensifier 115 captures data, holds data, and transmits data to the CCD 113. A Raman scattering circuit 131 controls all or portions of the photo-detector array 112 in several embodiments. In various embodiments, the image intensifier 115 captures photons, converts the photons to electrons, multiples them and converts that back to photons. Various embodiments communicate energy from the image intensifier to induce an electronic charge in the CCD.

Some embodiments include a receiver 114. The receiver 114 includes one or more diodes, in some embodiments. Additional embodiments include other structures. In various embodiments, the receiver 114 receives Rayleigh scattering. The receiver measures time-of-flight in some examples. Time-of-flight includes the measure of the time delay between a laser transmitter output pulse 107 and a returned signal such 116 as a Rayleigh returned signal. In various embodiment, the timing of the returned signal 116 provides an indicator of a preferred a delay between a transmitted pulse 108 and the time to enable the image intensifier 115. For example, in some embodiments, the image intensifier 115 is enabled only during the time necessary to capture Raman scattering at a desired level of fidelity, with a reduced influence of noise such as background noise. By opening the image intensifier gate just before the weak Raman signal is received and closing it immediately afterward, background noise can be suppressed. Light input to the receiver 114 can optionally be processed, such as by a filter.

Some embodiments include a background receiver 118. The receiver 118 includes one or more diodes, in some embodiments. Additional embodiments include other structures. In some examples, the background receiver 118 monitors intensity of background light. In various embodiments, the background receiver 118 monitors overall light level. In some of these embodiments, the background receiver 118 excludes the laser return. In some embodiments, this laser return is removed by the Rayleigh filter 120. Various embodiments include a Rayleigh band stop filter.

In some instances, the background measurement 117 can be used to estimate the amount of integration time required to detect the Raman signal. Some embodiments adjust the timing of enablement of the image intensifier 115 based on such an estimate. In additional embodiments, the background measurement can be used to estimate the amount of time the imagine intensifier should be activated and provide adjustments accordingly. Some embodiments adjust the laser optics 111 to control the influence of background light. Some embodiments estimate appropriate laser intensity for the laser output 108 and adjust the transmitter 108 or any optics influencing the transmitter 108 such as laser optics 111 accordingly.

Adjustments can occur automatically according to one or more algorithms stored in the system 100. Some embodiments record background noise and delay simultaneously, while additional embodiments stagger such recordings. Raman scattering, Rayleigh intensity, and Rayleigh delay can all be recorded simultaneously, or during a staggered approach including several cycles over which different spectra are recorded. The sensitivity of receiver 114 and the receiver 118 is not limited to any spectra, and detection of spectra not expressly disclosed herein is additionally possible in some instances.

In various embodiments, multiple cycles are used to develop a Raman spectrum. For example, according to some embodiments, a first cycle is executed in which an excitation laser output from transmitter 108 is emitted. In these embodiments, after a timed delay, the photo-detector array is enabled, such as via a gated signal, during a brief period of time for recording light. The light recording period is a period estimated to be long enough to capture Raman scattering without capturing unwanted light. The estimation can be based on, but is not limited to, measured background noise and a measured distance to a specimen.

The measured distance can be determined by measuring time of flight of a laser intended to cause Raman scattering, or it can be determined via a separate laser. Some embodiments estimate the light recording period by comparing distance to specimen and/or background intensity to a database of specified values.

Some embodiments operate in open loop and an operator inputs distance to a specimen and/or background intensity. Various embodiments limit the duration of the data transmission from the image intensifier to the CCD because Raman scatter occurs during a known time period, and limiting the exposure to the CCD to that time period ensures that the signal to noise ratio is sufficient to accurately capture a Raman spectrum.

Various embodiments communicate data from the image intensifier 115 to the CCD 113. Because the Raman scattering is weaker than other noise, various embodiments collect data over multiple cycles. Some embodiments pulse a laser at 1000 Hertz, for example, and record multiple samples, each sample recording reflected light and any background information. In various embodiments, information relating to Raman scattering is built up in the CCD or another component over time, according to statistical processing, such as averaging.

Some embodiments of the present subject matter indicate sufficient collection has occurred after a milestone has been reached. In some examples, Raman information exceeds a threshold, such as a peak threshold (e.g., in which counts exceed a specified peak threshold), an integration threshold (e.g., in which the area under a peak exceeds a specified integration threshold) or another threshold or combination of thresholds. In some examples, the predicted integrated Raman signal exceeds the background level after a certain number of laser pulses.

Some embodiments include a video receiver 122 that records video of a specimen at a measurement scene. Video record includes, but not limited to, the visible spectrum. The video receiver 122 can record video information useful for associating a measured spectrum with a picture or video of a specimen of interest. Video receiver 122 can augment noise information relating to a monitored scattering, such as a monitored Rayleigh or Raman scattering, by adding information from the visible spectrum. The illustrated video receiver 122 includes video optics 110 that are dedicated to processing light for the video receiver 122, but the present subject matter is not so limited, and embodiments are possible in which the video optics 110 are integrated with the laser optics 111. In various embodiments, the video receiver 122 records information including Rayleigh wavelength and Raman source area as well as visible surroundings seen within a camera sensitivity wavelength.

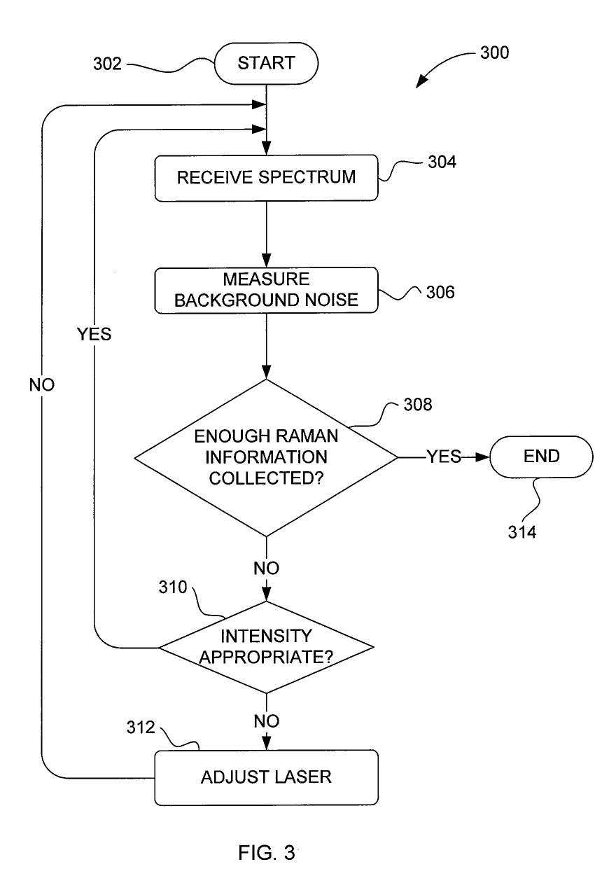

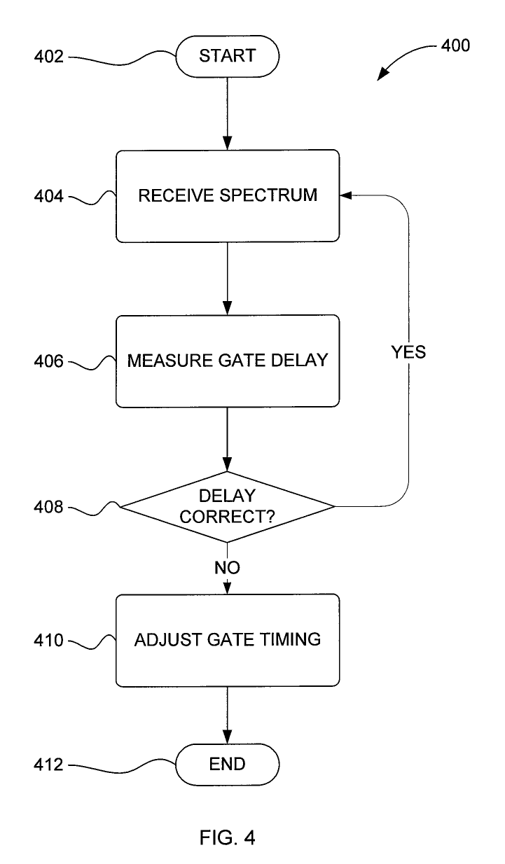

The illustration shows a controller 124. The controller 124 includes a gate adjust system 126 and a specified calibration 128. The gate adjust system 126 functions according to the flow charts illustrated in FIGS. 3-4 and discussed in the associated portions of the specification, although the present subject matter is not so limited. A delay circuit 127 is included in various embodiments and provides a time delay signal or a modified time delay signal to portions of the detector system 100 to time the function of those portions and disclosed herein. The specified calibration 128 includes, but it not limited to, default laser gate timing, pulse frequency, and intensity information associated with factors including, but not limited to, time of day, distance to target, etc. For example, in some embodiments, if time of day and distance to target is known, some embodiments of the present subject matter adjust laser pulse frequency, pulse width, and intensity to fire initially. After initial firing, embodiments of the present subject matter adjust one or more of the laser pulse frequency, laser pulse width, laser pulse intensity, laser optics 111, or pulse width for recording information with image intensifier 115. Some or all of the adjustments are automatic via feedback controls, in various examples.

Background noise is controlled, at least in part, by the background noise circuit 129, according to several embodiments disclosed herein, such as the embodiment disclosed in FIG. 3. In some examples, the controller 124 includes a feedback control circuit 133 that controls one or more of the circuits, including, but not limited to, delay circuit 127, Raman scattering circuit 131 and background noise circuit 129 using automatic controls. The controller 124 and each of these circuits can include hardware, software and/or a combination thereof, including, but not limited to, removable media. The controller 124 includes one or more integrated circuits, according to various embodiments.

Computer 130 is useful for pairing data representing Raman scattering, such as a Raman spectrum, with specified data to determine what compound(s) the Raman scattering represents. In various embodiments, Raman data is communicated over the data bus 106 and is compared with a specified composition, such as a composition stored in a database 134. In various embodiments, an algorithm 132 is used to perform a comparison. Example algorithms include, but are not limited to, principle component analysis.

In various embodiments, the results of the comparison are indicated to an interface 136. An interface 136 can output a signal carrying information, in some embodiments, via wires, optics, or wirelessly. In some embodiments, the interface includes a display. Displays contemplated include, but are not limited to, screens including touch screens, text bars, indicator lights, mechanical flags, and other displays. The interface 136 is used to modify the database 134 in some examples. In further examples, the interface can be used to download measured Raman data or processed Raman data.

In some embodiments, the computer 130 controls one or more mechanisms of the Raman module 104, such as the laser optics 111. In some examples, the computer 130 controls the laser light source 108 to provide Raman excitation light in a first mode, and range finding and distance measuring in a second mode.

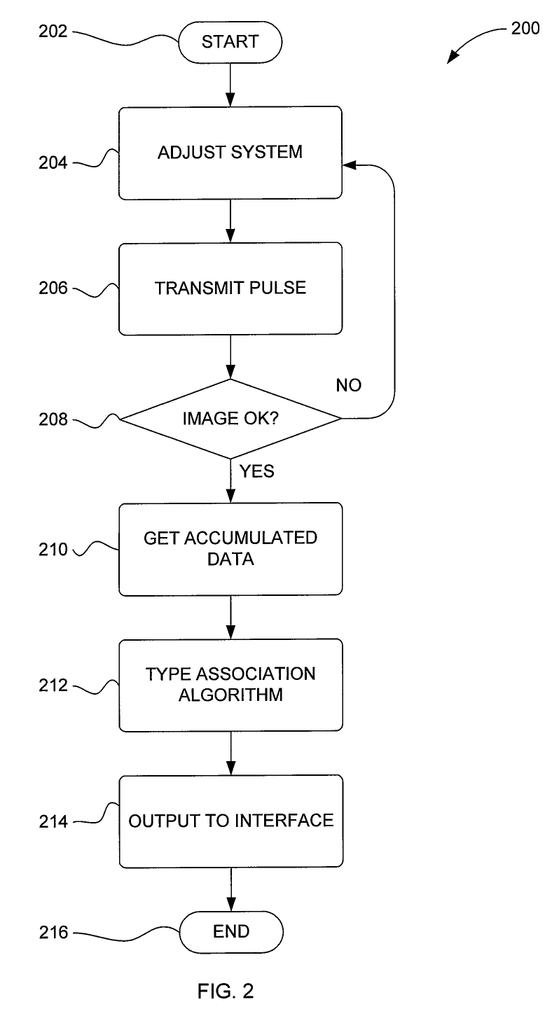

FIG. 2 is a flow chart of a method 200 of adjusting a Raman spectrometer, according to some embodiments. At 202, the method includes a start. At 204, if the method 200 has a system instruction, the method 200 adjusts the system. The system can use a default adjustment if an instruction is not available. System adjustments include, but are not limited to, adjustment to one or more of laser pulse frequency, laser pulse width, laser pulse intensity, laser optics, or pulse width for recording information with image intensifier. At 206, the method transmits a pulse such as a laser pulse. The present subject matter is not limited to transmission of any one pulse, and pulses contemplated include distance or location pulses, pulses intended to provoke Rayleigh scatter, pulses intended to provoke Raman scatter, pulses to provoke background noise, and other forms of photon energy.

Various method embodiments include switching a receiver image intensifier gate to allow Raman energy to accumulate on the CCD after Raman energy has been generated at the target by the excitation laser emitting laser energy. In various embodiments, at other times, when the received signal does not contain Raman energy, the image intensifier gate is turned off. In some examples, this is according to a square wave when represented in a time-domain, but the present subject matter is not so limited, and extends to sinusoidal waves, saw tooth waves, and other waves.

At 208, the method 200 determines if an image is acceptable, such as by referencing a submethod, such as one or more of those referenced in FIGS. 3-4. These methods provide one or more adjustments to the spectrometer as disclosed herein.

At 210, the method 200 receives data accumulated, such as by a sensor. The method 200 can optionally process the data, such as by applying one or more software or hardware filters. At 212, the method 200 associates data (e.g., such as from step 210) with known data in a database via one or more algorithms. These algorithms can include statistical components such as correlation. At 214, the method 200 displays results, if any, of the association to a display. In some examples, if the data is insufficient to result in a conclusion, an indicator that further measurement is needed is provided. The method ends at 216.

Method 200 can additionally include other steps in some embodiments. For example, some embodiments increase integration time automatically. Increased integration consumes computer resources, power and time, but can provide increased data fidelity. In some examples, integration adjustment is automatic, controlled according to comparisons to specified values, and in additional examples, integration adjustment is manual, such a via a user input (e.g., rotation of a knob, programming of an interface, and the like).

FIG. 3 is a flow chart of a method 300 of adjusting a Raman spectrometer, according to some embodiments. While accumulating the Raman spectrum from multiple pulses, embodiments of the present subject matter measure background noise. Additional embodiments monitor laser intensity. Laser intensity can be monitored by recording various parameters of Raman spectrometers (such as a signal output from a laser controller) or in relation to received spectra. In some embodiments, background noise can be measured before starting a Raman spectrum recording method. In additional embodiments, including the illustrated embodiment, background noise is measured during a Raman spectrum recording method.

The present subject matter, in some embodiments, estimates accumulated Raman information. In various embodiments, this estimation is based on background noise. In additional embodiments, this is based on the laser, including, but not limited to, target distance, the laser beam dispersion angle, the pulse repetition frequency and the laser output (e.g., such as to energy, pulse width, etc.). In various embodiments, when the amount of Raman data collected, such as via statistical methods for collecting and processing data, is sufficiently large compared to the measured background noise, the method stops pulsing the laser. What is sufficiently large is according to an estimation in some embodiments. Additional embodiments analyze a spectrum to determine if the spectrum is accurate, such as by comparing the spectrum to a specified value. In some embodiments, a Raman spectrum recording method stops accumulating Raman spectrum after sufficient information is recorded and outputs the contents of the CCD to another portion of a Raman spectrometer for further use.

Various methods of the present subject matter estimate (e.g., based on the target distance, the laser beam dispersion angle, the pulse repetition frequency and the laser output power) that light intensity at the specimen may be greater than eye-safe levels. In some of these embodiments, laser intensity is reduced via adjustment to pulse amplitude and/or by decreasing the pulse repetition frequency. These adjustments are sometimes not preferred as they can increase the amount of time required to accumulate the Raman spectrum. In some embodiments, if the light intensity on the target is too low, it will take excessive time to accumulate the Raman spectrum, so the methods increase the laser intensity. As such, various embodiments automatically balance the amount of time needed to collect a Raman spectra given a measured noise level with safe levels of laser output. By adjusting a Raman spectrometer to just under eye-safe levels, various embodiments can reduce the time needed to collect a sample without risking eye damage.

If eye damage is not an issue, various embodiments adjust the laser intensity to reduce spectrum collection time without causing further background noise. For example, some embodiments measure background noise caused by an environment, such as via solar or reflected solar light and via artificial light. Some of these embodiments estimate the time needed to collect a Raman sample, and then pulse a laser repeatedly during the estimated time to collect the sample. Various embodiments automatically adjust the number of pulses needed to collect sufficient Raman information in view of the laser intensity available according to certain constraints such as eye safety and/or allowable power consumption of a laser.

In various embodiments, the method 300 includes, at 302, a start. The method 300 includes, at 304 includes receiving a spectrum. In some embodiments, the spectrum is a full spectrum, including, but not limited to, Rayleigh information, any Raman information produced by an excitation, and noise. In additional embodiments, the spectrum is processed before it is utilized by the method 300.

At 306, the method 300 includes measuring the background noise of spectrum. This can include one or more measurement techniques, such as curve fitting, peak detection and integration. At 308, the method 300 includes a query as to whether enough Raman information can be collected. If it has, the method proceeds to an end 314. Some examples include a comparison at 308. In some examples, at 308, a curve can be fit to a known curve and deviance can be reported. A detected peak can be compared to a specified threshold, in additional instances. In some examples, an integration is compared to a threshold integration. These and other analysis techniques are possible without departing from the present subject matter. If enough Raman information has been collected, the method proceeds to an end 314. If it has not, it proceeds to further operations, such as those commencing at 310.

At 310, the method 300 queries as to whether the intensity of the laser is appropriate. Laser intensity can be too high, and it can be too low. If intensity is too high, there is a danger that a person's eyes can be damaged. Too much intensity can also increase the level of background noise. If it is too low, enough data might not be collected. If the intensity is appropriate, the system proceeds to record another spectrum at 304. If it is not, at 312, the method includes adjusting the laser. In some examples, pulse width is adjusted. In some example, pulse frequency is adjusted. In some examples, pulse amplitude is adjusted, with an increase in amplitude being associated with an increase in instant laser energy. Other adjustments are additionally possible, such as adjustments to optics. Some instances indicate that a Raman detector should be relocated because the location of the sun with respect to the orientation of the detector is not preferred. Some adjustments are automatic, such as via automatic controls. Examples are additionally possible in which an operator adjusts one or more controls manually based on readout such as readouts via an interface (e.g., a display). When the laser is adjusted, another spectrum is received at 304.

FIG. 4 is a flow chart of a method of adjusting gate timing, according to some embodiments. In various embodiments, the method 400 includes, at 402, a start. The method 400 includes, at 404 includes receiving a spectrum. In some embodiments, the spectrum is a full spectrum, including, but not limited to, Rayleigh information, any Raman information produced by an excitation, and noise. In additional embodiments, the spectrum is processed before it is utilized by the method 400. Some examples provide only a Rayleigh spectrum.

At 406, the method 400 includes measuring gate delay. This can be via time of flight, multiple frequency phase-shift and/or interferometry. This can include one or more measurement techniques, such as curve fitting, peak detection and integration. At 408, the method 400 includes a comparison. For example, at 408, a delay curve can be fit to a known curve and deviance can be reported. A detected peak can be compared to a specified threshold, in additional instances. In some examples, an integration is compared to a threshold integration. These and other analysis techniques are possible without departing from the present subject matter. Gate delay determination at 406 is normally determined by the relatively high power Rayleigh (the laser wavelength) return coming into a fast photodiode or other high-speed detector. If the gate delay does not reflect that the sensor receiving information is timed to match the emission of excitation energy and the distance the excitation energy travels, it is adjusted.

If the delay is correct, at 408, the method 400 allows for repeated use of the gate configuration. Because the Raman signal is extremely weak, integrated returns from many laser pulses are typically gated into the CCD to generate a detectable spectrum.

At 410, if the gate is not correct, the method 400 adjust the gate timing, such as by adjusting the wave-form used to enable the reception of energy via a sensor. This can include amplitude (i.e., sensitivity of the sensor), in some examples. In many examples, pulse width is adjusted. Other adjustments are additionally possible, such as adjustments to optics. Some instances indicate that a Raman detector should be relocated because the location of the sun with respect to the orientation of the detector is not preferred. The adjustment is automatic in some examples, such as according to automatic controls. Examples are additionally possible in which an operator adjusts one or more controls manually based on readout such as readouts via an interface (e.g., via a display). The method ends at 412.

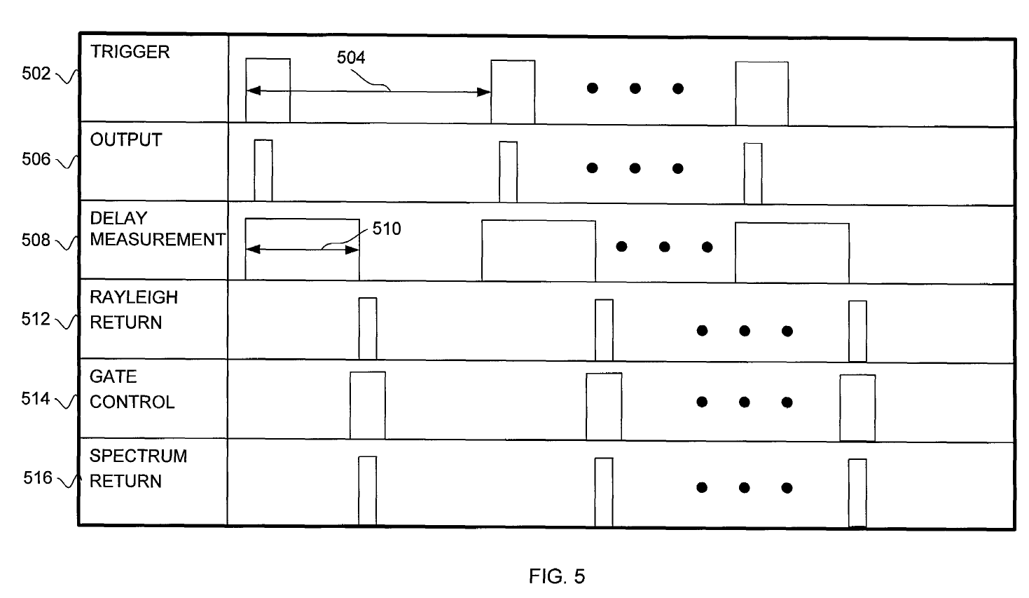

FIG. 5 is a diagram showing timing related to pulsed Raman spectroscopy, according to some embodiments. At 502, a trigger pulse is provided according to a square wave. Other waveforms are possible. The distance between the trigger 504 is the distance in time between a first Raman data collection cycle and a second Raman data collection cycle. For instance, according to some methods, enough Raman data is collected during a single Raman data collection cycle to determine the composition of a specimen. In additional methods, multiple Raman data collection cycles are used. The number of Raman data collection cycles used can be prescribed according to a user specified value, or automatically, such as until the collected data demonstrates certain properties, such as correlating to a specified statistical threshold. The collection cycle rate associated with trigger 504 can be adjusted to improve the quality of spectra received by a detector, in some examples. For example, if it is determined that a lower frequency provides for a better Raman spectrum, that frequency can become the operating frequency during the remainder of a Raman scattering detection operation. Determining whether a Raman spectrum or other associated data are sufficient occurs according to a signal analysis. In some instances such analysis includes curve fitting, peak detection, or other methods, including those disclosed herein.

At 506 an excitation energy, such as a laser, is output. Typically, this is a small part of a single Raman data collection cycle. At 508, the present subject matter provides a time delay. The time delay has a length 510. In various embodiments, the length 510 is modified to comprise a modified time delay. After the time delay 510, at 512 the system records photon energy returning due to the excitation caused by the output 506. In some examples, the returned energy include Rayleigh scatter, but the present subject matter is not so limited. Gate control of the sensors that record photon information is represented at 514. The gate at 514, in some embodiments, provides increased time to compensate for system lag. Although the gate control of 514 starts just before the return of 512 and terminates just after the return of 512, embodiments where it starts coincidentally and/or terminates coincidentally are additionally contemplated. At 516 a wave is represented that gates enabling of the return of a spectrum other than the spectrum of 512. For instance, a Raman spectrum is returned according to gate control algorithm of 516, in some examples.

The present subject matter encompasses several operational modes. In some examples, a first mode includes recording or enabling the recordation of only one spectrum (e.g., a Rayleigh or a Raman spectrum) at a time. In additional embodiments, multiple spectra can be recorded concurrently. In examples including concurrent recordation, simultaneous start and/or stop times are not necessary. In some embodiments including concurrent recordation, one sensor records multiple spectra. In additional examples, several sensors record one or more spectra.

Methods are contemplated wherein enabling the excitation laser, monitoring the photon scattering and adjusting the timed delay occur as part of a calibration cycle, and enabling the Raman spectrometer occurs after the calibration cycle and during a spectroscopy cycle in which a second excitation period includes enabling the excitation laser during a second excitation period. In some of these embodiments, the second excitation period, the modified timed delay, and the Raman monitoring period occur in sequence.

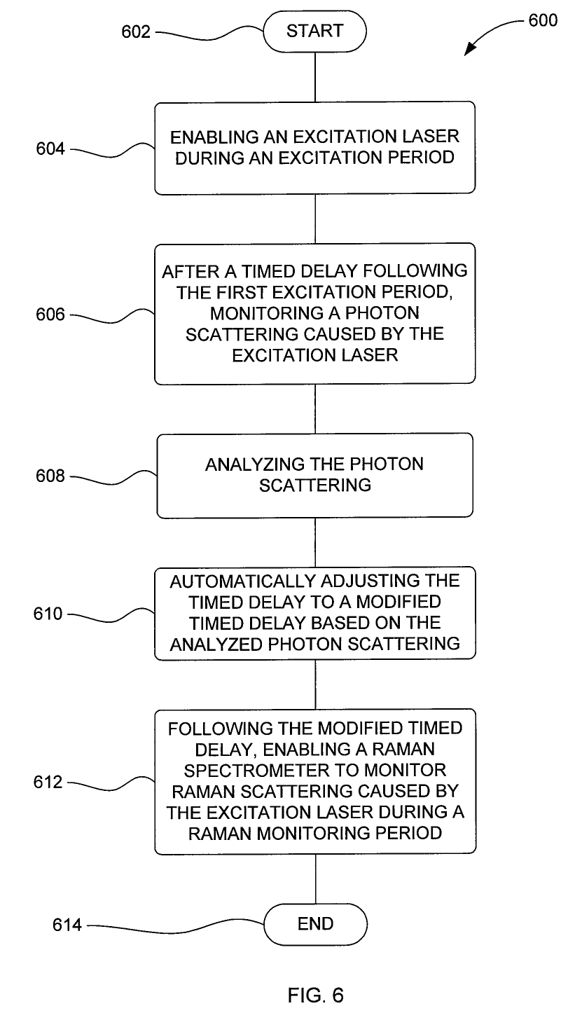

FIG. 6 is a flow chart of a method of automatically adjusting a Raman spectrometer, according to some embodiments. The method starts at 602. At 604, the method 600 includes enabling an excitation laser during an excitation period. At 606, the method 600 includes after a timed delay following the first excitation period, monitoring a photon scattering caused by the excitation laser. At 608, the method 600 includes analyzing the photon scattering. At 610, the method 600 includes automatically adjusting the timed delay to a modified timed delay based on the analyzed photon scattering. At 612, the method 600, following the modified timed delay, includes enabling a Raman spectrometer to monitor Raman scattering caused by the excitation laser during a Raman monitoring period. The method ends at 614.

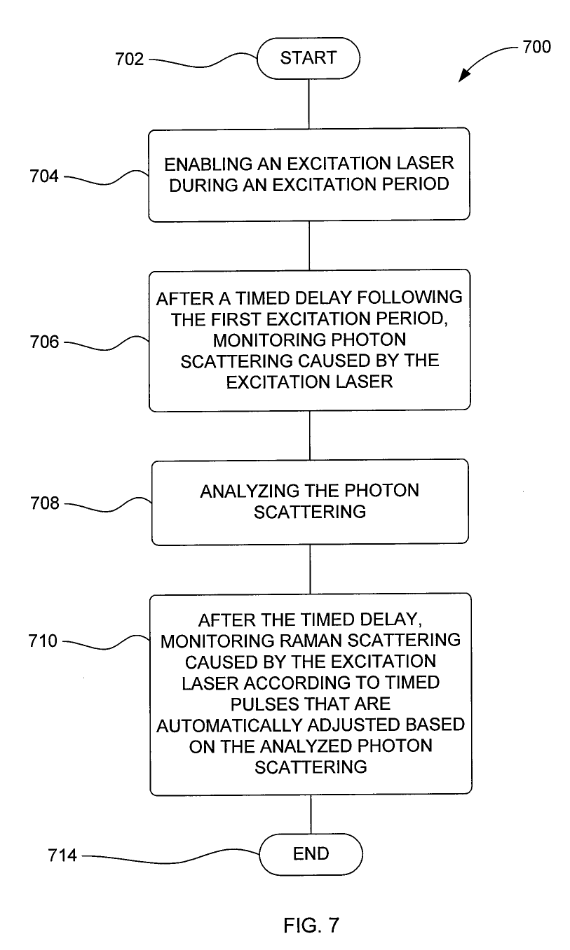

FIG. 7 is a flow chart of a method of automatically adjusting pulses of a controlled pulsed Raman spectrometer, according to some embodiments. The method starts at 702. At 704, the method includes enabling an excitation laser during an excitation period. At 706, the method, after a timed delay following the first excitation period, includes monitoring photon scattering caused by the excitation laser. At 708, the method includes analyzing the photon scattering. At 710, the method, after the timed delay, includes monitoring Raman scattering caused by the excitation laser according to timed pulses that are automatically adjusted based on the analyzed photon scattering. The method ends at 714.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

What is claimed is:

1. A method, comprising:
enabling an excitation laser during an excitation period;
after a timed delay following the excitation period, monitoring a photon scattering caused by the excitation laser;
analyzing the photon scattering;
automatically adjusting the timed delay to a modified timed delay based on the analyzed photon scattering; and
following the modified timed delay, enabling a Raman spectrometer to monitor Raman scattering caused by the excitation laser during a Raman monitoring period.

2. The method of claim 1, wherein analyzing the photon scattering includes analyzing background noise.

3. The method of claim 1, wherein enabling the excitation laser, adjusting the timed delay to a modified timed delay, and enabling the Raman spectrometer occur concurrently.

4. The method of claim 1, wherein enabling the excitation laser, monitoring the photon scattering and adjusting the timed delay occur as part of a calibration cycle, and enabling the Raman spectrometer occurs after the calibration cycle and during a spectroscopy cycle in which a second excitation period includes enabling the excitation laser during a second excitation period, with the second excitation period, the modified timed delay, and the Raman monitoring period occurring in sequence.

5. The method of claim 1, further comprising adjusting the length of the excitation period based on the analyzed photon scattering.

6. The method of claim 1, further comprising adjusting the length of the Raman monitoring period based on the analyzed photon scattering.

7. The method of claim 1, wherein the background noise level is monitored with a first sensor enabled during the first excitation period, and wherein Raman scattering is monitored with a second sensor, with the Raman monitoring period occurring within the excitation period.

8. The method of claim 1, wherein adjusting the timed delay to a modified timed delay includes adjusting time of flight of the excitation laser and of a returning photon.

9. The method of claim 1, wherein adjusting the timed delay to a modified timed delay includes adjusting intensity of the excitation laser.

10. The method of claim 1, further comprising analyzing the monitored Raman scattering and associating the Raman scattering with a specified composition.

11. The method of claim 9, further comprising indicating the composition and the modified time delay.

12. The method of claim 10, wherein indicating the composition includes displaying the composition visibly on a monitor.

13. An apparatus, comprising:
an excitation laser;
an excitation circuit coupled to the excitation laser to enable the excitation laser;
a delay circuit to indicate a timing delay signal after enabling the excitation laser;
a background noise sensor to monitor background noise of the excitation laser and to provide a background noise signal;
a background circuit coupled to the background noise sensor to enable the background noise sensor based on the timing delay signal;
a Raman scattering sensor to monitor Raman scattering of the excitation laser;
a Raman scattering circuit coupled to the Raman scattering sensor to enable the Raman scattering sensor based on the timing delay signal; and
a feedback control circuit to adjust the timing delay signal based on the background noise signal.

14. The apparatus of claim 12, further comprising:
a range finding laser to provide a distance signal; and
adjustable optics to filter the excitation laser based on the distance signal.

15. The apparatus of claim 13, wherein the adjustable optics are to filter the excitation laser based on the background noise signal.

16. The apparatus of claim 13, wherein the excitation laser is the range finding laser.

17. The apparatus of claim 12, wherein the Raman scattering sensor includes a charge-coupled device.

18. The apparatus of claim 12, wherein the background noise sensor includes a photodetector.

19. A method, comprising:
enabling an excitation laser during an excitation period;
after a timed delay following the first excitation period, monitoring photon scattering caused by the excitation laser;
analyzing the photon scattering; and
after the timed delay, monitoring Raman scattering caused by the excitation laser according to timed pulses that are automatically adjusted based on the analyzed photon scattering.

20. The method of claim 19, wherein monitoring the background noise level and monitoring Raman scattering occur concurrently.
